(19) United States
(12) Patent Application Publication
(10) Pub. No.: US 2010/0084448 A1
(43) Pub. Date: Apr. 8, 2010

(54) LINKAGE DEVICES FOR CONNECTING VEHICLE RACK SUPPORT MEMBERS TO VEHICLES

(75) Inventors: Doug Fjelland, Medford, OR (US); Chris Sautter, Portland, OR (US)

Correspondence Address: KOLISCH HARTWELL, P.C., 200 PACIFIC BUILDING, 520 SW YAMHILL STREET, PORTLAND, OR, 97204, US

(73) Assignee: Yakima Products, Inc., Beaverton, OR (US)

(21) Appl. No.: 12/494,223

(22) Filed: Jun. 29, 2009

Related U.S. Application Data
(60) Provisional application No. 61/133,440, filed on Jun. 27, 2008.

(51) Int. Cl. B60R 9/058; F16B 9/00; B60R 9/052

(52) U.S. Cl. 224/322; 403/188; 224/556

(57) ABSTRACT

Linkage devices for connecting vehicle rack support members to preexisting attachment points on vehicle upper surfaces are disclosed. The linkage devices may include a body, a resilient pad, and an anchoring member. The body may include an interface, configured to engage and retain the support member, and a substantially hollow lower portion having a lower edge that defines a circumference of an opening. The resilient pad may be disposed on the lower edge and extend around at least a first substantial portion of the circumference of the opening. The opening may extend through the resilient pad and into the substantially hollow lower portion. The anchoring member may be configured to extend through the substantially hollow lower portion and through the opening, engage the attachment point, and selectively urge the body against the resilient pad and the upper surface of the vehicle.

### CROSS-REFERENCE TO RELATED APPLICATIONS

This application claims priority under 35 U.S.C. §119(e) to U.S. Provisional Patent Application Ser. No. 61/133,440, which was filed on Jun. 27, 2008 and is entitled “Linkage Device for Connecting Rack Towers to Vehicle Roofs.” The complete disclosure of the above-identified patent application is hereby incorporated by reference for all purposes.

### FIELD OF THE DISCLOSURE

The invention relates to vehicle racks, and more particularly to linkage device for connecting vehicle rack support member to vehicles via factory-provided attachment mechanisms.

### BACKGROUND

Vehicles are often fitted with racks for carrying cargo boxes, recreational equipment mounts, and various other types of load carriers. These vehicle racks may include crossbars, rails, or other elongate structural members extending over the roof, or other upper surface, of the vehicle. For example, typical roof rack systems may include one or more crossbars extending generally perpendicular to the length of the vehicle. Each crossbar may be attached to an upper surface of the vehicle, such as the roof, via a pair of towers or support devices. In addition to coupling the crossbar to the vehicle, the support devices may also support the crossbars over the vehicle so that the crossbars do not contact the roof or other upper surface of the vehicle to which the rack is mounted.

The support devices for such racks may be mechanically attached to the roof of the vehicle. For example, the support devices may be attached to preexisting features on or near the vehicle roof such as tracks, rails, channels or rain gutters. The support devices may also be directly attached to the vehicle roof such as with screws that are driven into the roof itself. Some vehicles may include preexisting attachment points on the upper surface to which the support devices may be secured. Examples of structures for connecting vehicle racks to vehicle roofs are disclosed in U.S. Pat. Nos. 7,240,815; 7,017,788; 6,997,657; 6,905,053; 6,739,487; 6,311,882; 6,182,876; 6,010,048; 5,979,723; 5,282,562; 4,995,538; and 4,640,450; as well as in U.K. Patent No. GB 2,312,658. The complete disclosures of these and all other publications referenced herein are incorporated by reference in their entirety for all purposes.

### SUMMARY

In some examples, rack systems for carrying items on upper surfaces of vehicles may be configured for attachment to a plurality of preexisting attachment points disposed on the upper surface of a vehicle. The upper surface of the vehicle may have a profile. The rack system may include a crossbar and a pair of support devices configured to support the crossbar therebetween. Each of the support devices may include a tower portion, a base portion, a resilient pad, and an anchoring member. The tower portion may include a holding mechanism for securing a portion of the crossbar. The base portion may include an interface configured to support and retain the tower portion. The base portion may include a substantially hollow lower portion having a lower edge that defines a circumference of an opening. The resilient pad may extend around at least a first substantial portion of the circumference of the opening. The opening may be substantially unimpeded by the resilient pad. The anchoring member may be configured to extend through the substantially hollow lower portion and through the opening. The anchoring member may be configured to engage one of the preexisting attachment points and selectively urge the resilient pad against the upper surface of the vehicle around at least a second substantial portion of the circumference of the opening. In some examples, the anchoring member may be configured to urge the resilient pad against the upper surface of the vehicle around at least a second substantial portion of the circumference of the opening substantially independently of the profile of the upper surface.

In some examples, support devices for securing vehicle racks to a vehicle may be configured to secure the vehicle rack to preexisting attachment points disposed on an upper surface of the vehicle. The support device may include a tower portion, a base portion, a resilient pad, and an anchoring member. The tower portion may include a holding mechanism for receiving and securing a portion of the vehicle rack. The base portion may include an interface configured to support and retain the tower portion. The base portion may include a substantially hollow lower portion having a lower edge that defines a circumference of an opening. The resilient pad may extend around at least a first substantial portion of the circumference of the opening. The opening may extend through the resilient pad and into the substantially hollow lower portion. The anchoring member may be configured to extend through the substantially hollow lower portion and through the opening. The anchoring member may be configured to engage the preexisting attachment point and selectively urge the base portion against the resilient pad and the upper surface of the vehicle around a second substantial portion of the circumference of the opening. In some examples, the second substantial portion of the circumference of the opening may be substantially coextensive with the first substantial portion of the circumference of the opening.

In some examples, linkage devices for connecting vehicle rack support members to a vehicle may be configured to connect vehicle rack support members to preexisting attachment points disposed on an upper surface of the vehicle. The linkage devices may include a body, a resilient pad, and an anchoring member. The body may include an interface configured to engage and retain the support member. The body may include a substantially hollow lower portion having a lower edge that defines a circumference of an opening. The resilient pad may be disposed on the lower edge and may extend around at least a first substantial portion of the circumference of the opening. The opening may extend through the resilient pad and into the substantially hollow lower portion. The anchoring member may be configured to extend through the substantially hollow lower portion and through the opening. The anchoring member may be configured to engage the preexisting attachment point and selectively urge the body against the resilient pad and the upper surface of the vehicle over a second substantial portion of the circumference of the opening. In some examples, the second substantial portion of the circumference of the opening may be substantially coextensive with the first substantial portion of the circumference of the opening.

### BRIEF DESCRIPTION OF DRAWINGS

FIG. 1 is a perspective view of a portion of a vehicle rack system mounted on a vehicle roof, with the rack system including a nonexclusive illustrative example of a linkage device for connecting the vehicle rack system to a vehicle.

FIG. 2 is an exploded perspective view of the vehicle rack system of FIG. 1, showing the linkage device.

FIG. 3 is a perspective bottom view of the linkage device shown in FIG. 2.

FIG. 4 is an exploded perspective view of the linkage device shown in FIG. 2.

FIG. 5 is a sectional view of the linkage device shown in FIG. 2, taken generally along line 5-5 in FIG. 2, with the linkage device shown secured to the vehicle by a nonexclusive illustrative example of an anchoring member.

FIG. 6 is a sectional view of the linkage device shown in FIG. 2, taken generally along a line corresponding to line 5-5 in FIG. 2, with the linkage device shown secured to the vehicle by another nonexclusive illustrative example of an anchoring member.

FIG. 7 is a top view of the linkage device shown in FIG. 2 shown installed on a vehicle roof, with several vehicle rooftop channel or track alignments illustrated.

FIG. 8 is a perspective view of a portion of a vehicle rack system mounted on a vehicle roof, with the rack system including another nonexclusive illustrative example of a linkage device for connecting the vehicle rack system to a vehicle.

FIG. 9 is a bottom perspective view of the linkage device shown in FIG. 8.

FIG. 10 is a perspective view of another nonexclusive illustrative example of a linkage device for connecting a vehicle rack system to a vehicle.

FIG. 11 is a sectional view of the linkage device shown in FIG. 10, taken generally along line 11-11 in FIG. 10, with the linkage device shown secured to the vehicle by a nonexclusive illustrative example of an anchoring member.

FIG. 12 is a bottom perspective view of the linkage device shown in FIG. 10.

### DESCRIPTION

The present disclosure describes a system and apparatus for securing a load-carrying rack to a vehicle. Vehicle racks may be mounted on any type of vehicle (e.g., car, van, truck, etc.), and some vehicle manufacturers provide attachment points for securing a rack on some vehicle models. While racks are often mounted on the roofs of vehicles, racks may also be mounted on other parts of a vehicle, such as the trunk or rear of the vehicle. Vehicle racks may include bars, such as crossbars and/or rails, for securing and supporting loads.

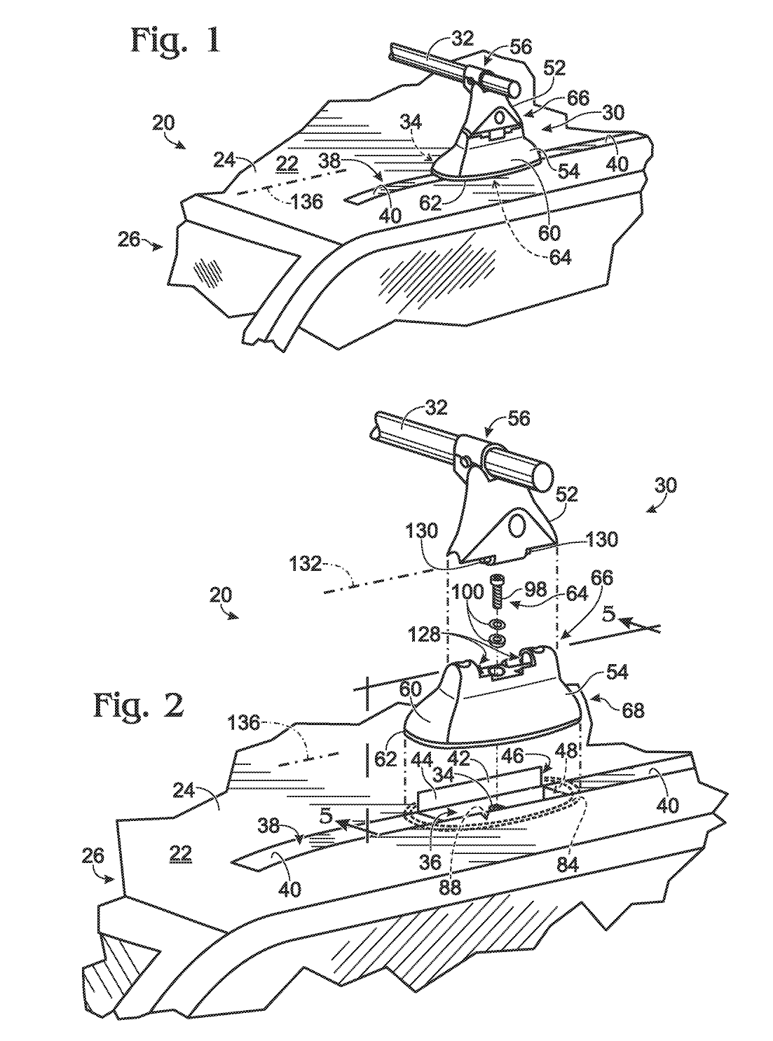

A nonexclusive illustrative example of a vehicle rack system is shown generally at 20 in FIGS. 1 and 2. Unless otherwise specified, vehicle rack system 20 and/or its various components may, but are not required to, contain at least one of the structure, components, functionality, and/or variations described, illustrated, and/or incorporated herein. As shown in FIGS. 1 and 2, the vehicle rack system 20 may be mounted to an upper surface 22, such as the roof 24, of a vehicle 26. The rack system 20 may include at least one support device 30 configured to secure at least a portion of the rack system 20 to the upper surface 22 of the vehicle 26. For example, the rack system 20 may include a pair of support devices 30 that are configured to support a crossbar 32 therebetween.

The vehicle 26 may include a plurality of preexisting attachment points 34 disposed on its upper surface 22, as shown in FIG. 2. The preexisting attachment points 34 may be factory installed components, or they may be aftermarket modifications to an existing vehicle. As will be more fully discussed below, nonexclusive illustrative examples of attachment points 34 may include female threaded fasteners or sockets; male threaded fasteners or studs; metal loops, hoops, openings, edges, posts or shelves; and/or any suitable feature that may be selectively mechanically gripped by a suitably configured member, fastener and/or engager. Such attachment points may be permanently attached to the vehicle or they may be removable.

As shown in the example of FIG. 2, some vehicles may include a single attachment point 34 at each location such that a single attachment point 34 is used to engage each support device 30. However, other vehicles may include multiple attachment points to engage each support device 30 and/or to provide a range of adjustments for use when installing the rack system. Some vehicles may include extra attachment points such that not all attachment points are used when mounting a rack system. For example, a vehicle may include six, eight, or even ten or more attachment points such that a user may select which of the attachment points, for example which four attachment points, should be used to mount a rack system. Vehicles having more attachment points than are necessary to secure the support devices of a particular rack system may allow for selective placement of the rack system on a vehicle roof, such as closer to the front or rear of a vehicle, and/or allow for variable spacing between the crossbars of a rack system.

The attachment points 34 may be disposed in wells or pockets 36, as shown in FIG. 2. The pockets 36 may be portions of an existing rain gutter or channel 38 on the roof 24 of the vehicle 26. At least a portion of the channel 38 may include a cap 40, which may form a portion of the upper surface 22 of the vehicle 26.

In some examples, the upper surface 22 of the vehicle 26 may include a cover member 42 disposed proximate at least some of the attachment points 34. As shown in FIG. 2, the cover member 42 may be in the form of a hinged or pivoting door 44. Such a cover member 42 may be configured to pivot between an open position 46, in which the cover member 42 projects above the upper surface 22 of the vehicle 26 and exposes attachment point 34, as shown in FIG. 2, and a closed position 48, in which the cover member 42 is substantially flush with the upper surface 22 of the vehicle 26 and would substantially conceal the attachment point 34 and/or the pocket 36. The cover member 42 may pivot from or relative to any side or portion of the pocket 36, such as where the cover members pivot along an axis that is aligned with the length of the pocket 36 or the channel 38 or an axis that is transverse to the channel 38. In some examples, rather than pivoting, the cover member may slide between open and closed positions and or be detachable, such that the cover member is removed from the upper surface of the vehicle to expose the underlying attachment point.

Each support device 30 may include a support member or tower portion 52 and a base portion or linkage device 54, as shown in FIGS. 1 and 2. The tower portion 52 may be configured to receive and secure a portion of the vehicle rack system 20. For example, the tower portion 52 may include a holding mechanism 56 configured to engage and secure a portion of the crossbar 32. The holding mechanism 56 may include any suitable structure configured to securely engage a crossbar, such as the structure disclosed in U.S. Pat. No. 6,905,053, the complete disclosure of which is incorporated by reference in its entirety for all purposes.

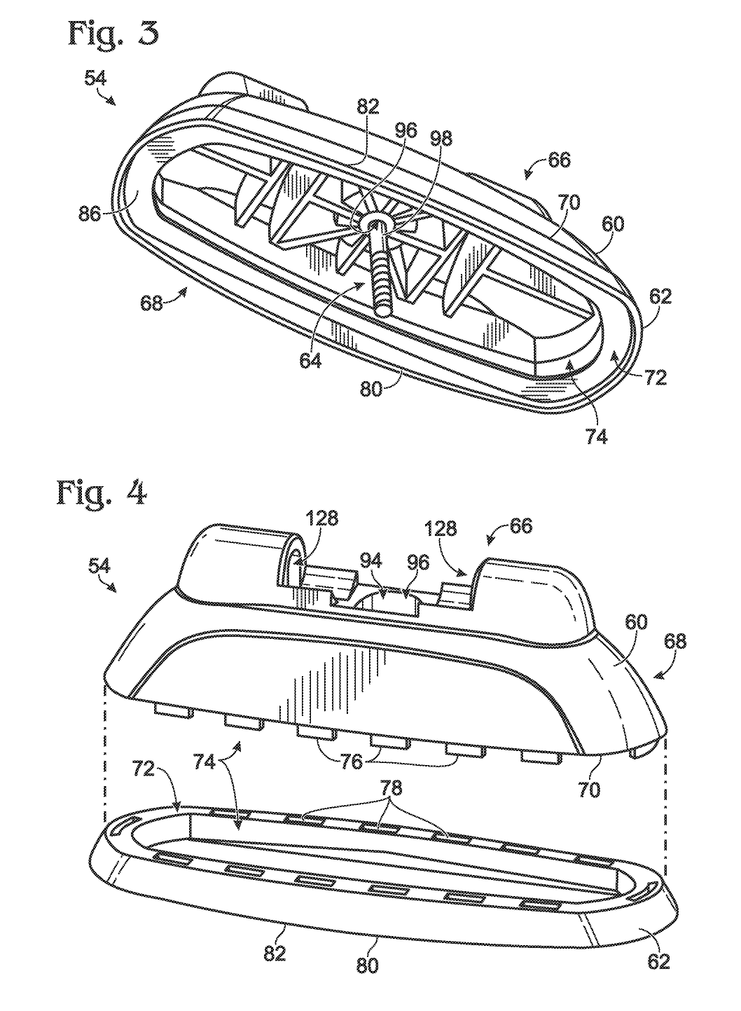

A nonexclusive illustrative example of a linkage device 54 is shown in FIGS. 2-7. Unless otherwise specified, linkage device 54 and/or its various components may, but are not required to, contain at least one of the structure, components, functionality, and/or variations described, illustrated, and/or incorporated herein. As shown in FIGS. 2-7, the linkage device 54 may include a body 60, a resilient pad 62, and an anchoring member 64. The resilient pad may be fabricated from a suitable elastomeric material, such as one having a desirable stiffness and resistance to wear and/or environmental effects. The body 60 of the linkage device 54 may include an interface 66 and a substantially hollow lower portion 68. As shown in FIGS. 3-6, the substantially hollow lower portion 68 of the body 60 may include a lower edge 70 that defines a circumference 72 of an opening 74.

The resilient pad 62 may be disposed on the lower edge 70 of the body 60 and may extend over, around or along at least a substantial portion of the circumference 72 of the opening 74. The resilient pad may be made of any material that provides sufficient flexibility to accommodate a range of vehicle surface profiles, while being stiff enough to be supportive under the typical loading of a vehicle rack and supported cargo. In a preferred embodiment, the pad or skirt may be made of a thermoplastic elastomer, namely Dynaflex G-2709 which is a 53 share A durometer thermoplastic elastomer. In the example shown in FIGS. 2-4, the resilient pad 62 extends around the entire circumference 72 of the opening 74. However, it is within the scope of the disclosure that the resilient pad 62 extends around less than the entirety of the circumference 72 of the opening 74. For example, the resilient pad may include one or more joints or gaps and/or the resilient pad may include a plurality of segments or sections that are spaced along the circumference of the opening on the body such that one or more gaps may be present between adjacent ones of the plurality of segments or sections. As shown in FIGS. 3-6, the opening 74 may extend through the resilient pad 62 and into the substantially hollow lower portion 68 of the body 60 such that the opening 74 is substantially unimpeded by the resilient pad 62.

The resilient pad 62 may be attached to the body 60, either permanently or temporarily, or it may be unattached. Nonexclusive illustrative examples of attachment methods may include adhesive or mechanical bonding, such as where the resilient pad 62 is screwed, clamped, pinched and/or otherwise attached to the body 60. In some examples, the resilient pad 62 and/or the body 60 may include one or more alignment features that may at least partially retain the resilient pad 62 in a particular position relative to the body 60. For example, as shown in FIG. 4, the body 60 may include a plurality of projections or tabs 76, which may be engaged with a plurality of corresponding receptacles or slots 78 on the resilient pad 62.

In some examples, the resilient pad 62 may be configured to at least partially provide a seal against the upper surface 22 of the vehicle. Such a seal may reduce or limit debris and/or water intrusion into the pocket 36. In such an example, the resilient pad 62 may be configured to adapt or conform to some amount of variation in the surface shape, profile, curvature or configuration of the upper surface 22, including character lines and/or gaps, grooves or bumps that may be present around the channels 38 and/or the caps 40 and/or variations in surface shape or profile of the upper surface 22 between different vehicles. In some examples, the resilient pad 62 may include a sealing member such as a pliable skirt 80, as shown in FIGS. 3, 5 and 6, which may be disposed along an outer edge 82 of the resilient pad 62.

The anchoring member 64 may be configured to selectively urge the body 60 of the linkage device 54 against the resilient pad 62 and the upper surface 22 of the vehicle, such that the body 60 urges the resilient pad against the upper surface of the vehicle. As generally shown in FIGS. 2, 3 and 5, the anchoring member 64 may extend through the substantially hollow lower portion 68 of the body 60 and through the opening 74 to where it may selectively engage one of the preexisting attachment points 34. The engagement between the anchoring member 64 and the attachment point 34, as well as the mechanisms by which the anchoring member 64 urges the body against the resilient pad and the upper surface, will be more fully discussed below.

The anchoring member 64 may urge the body 60 of the linkage device 54 against the resilient pad 62, such that the body 60 urges the resilient pad 62 against the upper surface 22 of the vehicle over, around or along at least a substantial portion of the circumference 72 of the opening 74. In some examples, the resilient pad 62 may be urged against the upper surface 22 around a portion of the circumference 72 of the opening 74 that is substantially coextensive with the portion of the circumference 72 around which the resilient pad 62 extends such that substantially the entire circumferential length of the resilient pad 62 is urged against the upper surface 22. Thus, where the resilient pad 62 extends around the entire circumference 72 of the opening 74, as generally shown in FIGS. 1-3, the anchoring member 64 and the body 60 may urge the resilient pad 62 against the upper surface 22 of the vehicle 26 around substantially the entire circumference 72 of the opening 74. In such an example, the linkage device 54 and its resilient pad 62 may reduce or limit debris and/or water intrusion into the pocket 36.

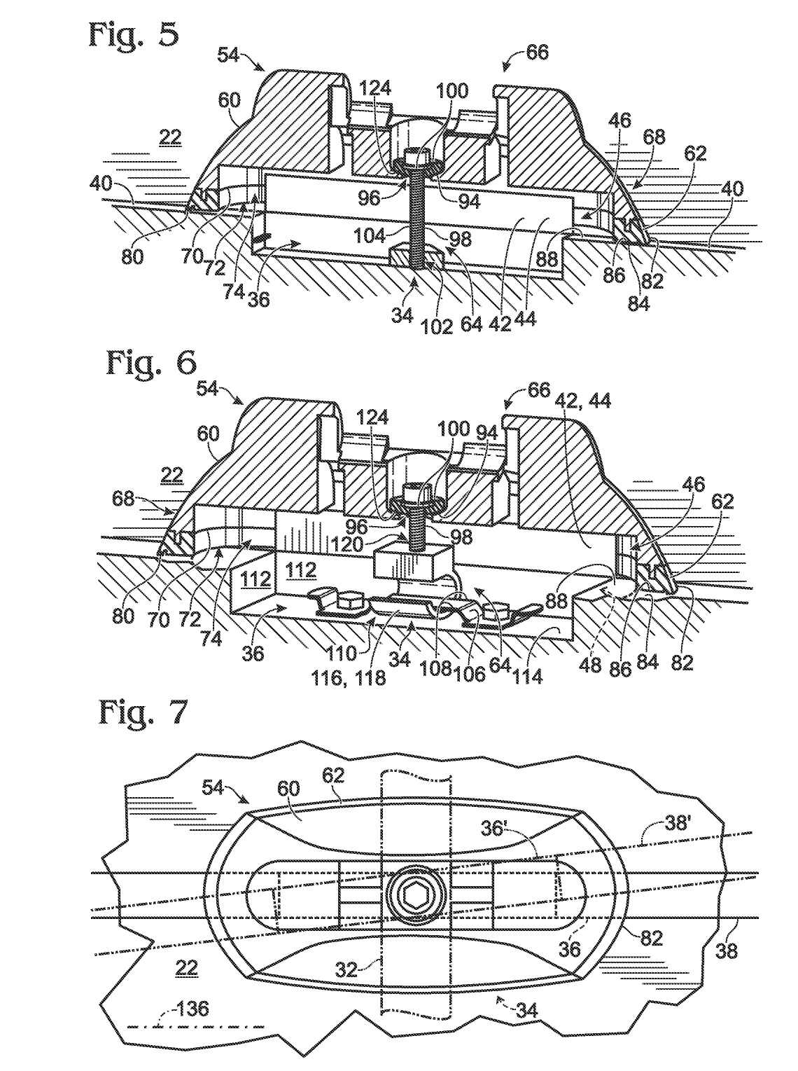

The anchoring member 64 and body 60 may urge the resilient pad 62 against the upper surface 22 of the vehicle over a contact area 84 of the upper surface. As shown in FIG. 5, the contact area 84 of the upper surface 22 may generally correspond to a substantial portion of the of the lower surface 86 of the resilient pad 62. In examples where the lower surface 86 is substantially even and continuous around the circumference 72 of the opening 74, as shown in FIGS. 3 and 5, the resilient pad 62 may engage the upper surface 22 over a contact area 84 that is substantially contiguous and/or relatively uninterrupted around some portion of the circumference 72. In such an example, the attachment point 34 would be disposed within, and the anchoring member 64 engaged with the attachment point would pass through, a region 88 of the upper surface that is exclusive of, and substantially surrounded by, the contact area 84. Passing the anchoring member 64 through the region 88 may enhance the lateral and/or fore-to-aft stability of the linkage device 54 due to the contact between the resilient pad 62 and the upper surface 22 at multiple opposed portions of the contact area 84, which may be located in opposite regions of the contact area 84 relative to the anchoring member 64.

In some examples, the linkage device 54 may be configured such that contact between the linkage device 54 and the vehicle is limited to the engagement of the resilient pad 62 with the upper surface 22 and the engagement of the anchoring member 64 with the attachment point 34. In such an example, when the anchoring member 64 selectively compresses the body 60 against the resilient pad 62, which is compressed against the upper surface 22, all compressive loads transmitted between the linkage device 54 and the upper surface 22 of the vehicle would pass through the resilient pad 62 and the contact area 84. However, even though all compressive loads applied to the upper surface 22 may pass through the resilient pad 62, the contact area 84 may be large enough relative to the loads transmitted to the upper surface 22, and/or the loads may be relatively evenly distributed over the contact area 84, that the contact pressures on the upper surface 22 are relatively low, which may reduce or prevent damage to the upper surface or its finish.

The anchoring member, and its various components, may be configured for use with various attachment point configurations. The anchoring member may include any suitable structure and/or mechanism that, when engaged with the attachment point 34, is configured to selectively urge the body against the resilient pad 62 and the upper surface 22. For example, the anchoring member and/or the attachment point may include one or more threaded components. When the anchoring member and/or the attachment point include threaded components, it should be understood that either or both of the anchoring member and the attachment point may include male and/or female components. For example, the anchoring member may include a male threaded component, such as a bolt or screw, which may be configured to engage a corresponding threaded female socket of the attachment point. However, in some examples, the anchoring member may include a female threaded component, which may be configured to engage a corresponding male threaded component, such as a male threaded stud, of the attachment point. In some examples, the anchoring member might also or alternatively include a cam or other structure that is configured to selectively reduce a clamped distance between at least a portion of the linkage device and the attachment point and/or otherwise induce a clamping load that urges the linkage device toward the attachment point and against the upper surface of the vehicle.

In the example shown in FIGS. 2-5, the body 60 includes a bearing surface 94 with an aperture 96 extending through the bearing surface 94 and into the substantially hollow lower portion 68 of the body 60, and the anchoring member 64 includes a threaded fastener 98, and at least one washer 100. As show in FIGS. 3 and 5, the threaded fastener 98 extends through the aperture 96 and into the substantially hollow lower portion 68 of the body 60.

As the details of the attachment points may vary amongst different vehicles, various anchoring members may be included or used with the linkage device 54 such that the linkage device may be compatible with the attachment points on different vehicles. FIGS. 5 and 6 illustrate several nonexclusive illustrative examples of anchoring members 64 that may be used with several nonexclusive illustrative examples of attachment points 34. It should be understood that the particular examples presented in FIGS. 5 and 6 also illustrate concepts for anchoring members that would be compatible with attachment point configurations other than those explicitly illustrated herein.

In the example shown in FIG. 5, the anchoring member 64 includes a threaded fastener 98 and the attachment point 34 includes a threaded receiver 102 disposed within the pocket 36 and at least partially below the upper surface 22 of the vehicle. The threaded fastener 98 is configured to engage the threaded receiver 102 to selectively urge the body 60 of the linkage device 54 against the resilient pad 62 and the upper surface 22 of the vehicle, which urges the resilient pad against the upper surface of the vehicle. In the example shown in FIG. 5, the threaded fastener 98 is a male threaded bolt 104, and the threaded receiver 102 of the attachment point 34 includes a female threaded socket. However, it should be understood that the threaded fastener 98 may be either a male or female component with the threaded receiver 102 being a corresponding female threaded socket or male threaded stud.

In the example shown in FIG. 6, the attachment point 34 includes a loop 106 that is disposed within the pocket 36 and at least partially below the upper surface 22 of the vehicle. The loop 106 may be an integral, or permanently attached, component of the upper surface 22 and/or the pocket 36, or the loop 106 may be removable and/or adjustable. The loop 106 may include an edge 108 and an opening 110, either or which may be disposed proximate or at least partially below the upper surface 22. Although the edge 108 and the opening 110 are illustrated in FIG. 6 as being part of a loop 106, it should be understood that the attachment point 34 may include an edge 108 and/or an opening 110 in the absence of a loop 106. For example, an edge 108 and/or an opening 110 may be formed as a portion of the cap 40 and/or the pocket 36, such as on a wall 112 and/or the bottom 114 of the pocket 36.

As shown in the example of FIG. 6, the anchoring member 64 includes a threaded fastener 98 and an engager 116, such as a hook 118. The engager 116 includes a threaded receiver 120, and the threaded fastener 98 engages the threaded receiver 120 to selectively draw the engager 116 toward the bearing surface 94 of the body. The engager 116 is configured to engage a suitable portion of the loop 106, such as the edge 108 and/or the opening 110. The anchoring member 64 shown in FIG. 6 is configured to selectively urge the body 60 of the linkage device 54 against the resilient pad 62 and the upper surface 22 of the vehicle, when the threaded fastener 98 selectively draws the engager 116 toward the bearing surface 94, which urges the resilient pad against the upper surface of the vehicle. In the example shown in FIG. 6, the threaded fastener 98 is a male threaded bolt, and the threaded receiver 120 of the engager 116 includes a female threaded socket. However, it should be understood that the threaded fastener 98 may be either a male or female component with the threaded receiver 120 being a corresponding female threaded socket or male threaded stud.

The linkage device 54, and its various components, may be configured such that the linkage device is compatible and/or usable with a range of vehicle upper surface shapes, profiles, configurations, curvatures and/or character lines, including variations that might exist between different vehicles. For example, the resilient pad 62 and/or the body 60 may be configured such that the anchoring member 64 and body 60 may urge the resilient pad 62 against the upper surface 22 of the vehicle along at least a substantial portion of the circumference 72 of the opening 74 substantially independently of any particular profile and/or shape of the upper surface 22. For example, the resilient pad 62 may be sufficiently thick and/or pliable such that the resilient pad may conform to a range of upper surface shapes, profiles, configurations, curvatures and/or character lines. The lower edge 70 of the body 60 may additionally or alternatively be shaped and/or sized to relatively closely match the profile and/or shape of a range of vehicle upper surfaces. For example, the lower edge 70 may be manufactured with a particular size and/or shape that corresponds to a relatively common, or average, vehicle upper surface profile, such as one having moderate amounts of fore-to-aft and/or side-to-side curvature.

The linkage device 54 may be used with attachment points 34 that are disposed at varying depths below and/or above the upper surface 22. For example, the anchoring member 64 may include threaded fasteners of various lengths to address the varying distances between the bearing surface 94 and the attachment points 34. Furthermore, variable numbers of washers 100 may be used to provide additional control over the effective length of the anchoring members.

In some examples, the body 60 and/or the anchoring member 64 may be configured to accommodate some degree of misalignment between the body, the attachment point 34, and/or the upper surface 22. As shown in the example of FIGS. 5 and 6, the bearing surface 94 may have a rounded or spherical profile configured to receive a corresponding spherical mating surface 124 on one of the washers 100.

In some examples, the linkage device 54 may be configured to provide clearance for the cover member 42 when the linkage device is secured to an attachment point 34. For example, as shown in FIGS. 5 and 6, the opening 74 and/or the substantially hollow lower portion 68 of the body 60 may be configured such that the cover member 42, in its open position 46, may extend through the opening 74 and into the substantially hollow lower portion 68, such as without contacting the body 60, when the anchoring member 64 urges the body 60 against the resilient pad 62 and the upper surface 22. In some examples, the opening 74 and/or the substantially hollow lower portion 68 of the body 60 may be sized such that a range of cover member sizes and shapes may extend through the opening 74 and into the substantially hollow lower portion 68.

The interface 66 may be configured to engage, support and retain the tower portion 52 to the linkage device 54. For example, as shown in FIGS. 2 and 4, the interface 66 may includes one or more recesses 128, and the tower portion 52 may include one or more locking pins 130 that may be selectively movable into engagement with the one or more recesses 128 to retain the tower portion 52 when the tower portion is supported by the interface 66. Further details regarding such an interface are disclosed in U.S. Pat. No. 6,905,053, the complete disclosure of which is incorporated by reference in its entirety for all purposes.

In some examples, the interface 66 may be configured such that the tower portion 52 is pivotable relative to the body 60 of the linkage device 54. For example, as shown in FIG. 2, the locking pins 130 may have a substantially circular cross section such that the locking pins 130 define an axis 132. In such an example, the tower portion 52 is pivotable about the axis 132 when the interface 66 supports and retains the tower portion 52 and the locking pins 130 are engaged with the recesses 128.

In some examples, the support device 30 may be configured such that the anchoring member 64 urges the body 60 of the linkage device 54 against the resilient pad 62 and the upper surface 22 of the vehicle around at least a substantial portion of the circumference 72 substantially independently of any particular profile or shape of the upper surface 22, doing so without inducing a bending moment into the crossbar 32. In some examples, the anchoring member 64 may urge the body 60 against the resilient pad 62 and the upper surface 22 of the vehicle along substantially the entire length of the resilient pad 62 without regard to any particular profile or shape of the upper surface 22, and do so without inducing a bending moment into the crossbar 32. For example, an interface 66 that allows the tower portion 52 to pivot relative to the linkage device 54 may permit both linkage devices 54 to be pivoted as needed to engage vehicle upper surfaces that have a range of side-to-side shapes and/or curvatures.

In some examples, the linkage device 54 may be secured to the attachment point 34 in a selected one of a plurality of orientations. For example, as shown in FIG. 7, the linkage device 54 may be substantially aligned with the pocket 36 and/or the channel 38 (as shown in solid lines). Such an alignment could be used when the pocket 36 and/or the channel 38 are substantially aligned parallel to, or otherwise suitably aligned with, the long axis 136 of the vehicle such that the crossbar 32 would be substantially perpendicular to the pocket 36 and/or the channel 38. However, in some examples, the linkage device 54 may be pivoted about the attachment point 34, and rotated relative to the pocket 36′ and/or the channel 38′ (as shown in dash-double-dot lines in FIG. 7), which would allow the linkage device 54 to be substantially parallel to the long axis 136 of the vehicle 26, and substantially perpendicular to the crossbar 32, even where the pocket and/or the channel are not substantially parallel to the long axis of the vehicle.

In some examples, engaging a tower portion 52 on the interface 66 may impede removal of the linkage device 54 from the upper surface 22 of the vehicle. For example, as shown in FIGS. 1 and 2, the tower portion 52, when engaged with the interface 66, may impede or prevent access to the anchoring member 64 such that the anchoring member 64 may not be disengaged from the attachment point 34, which would prevent removal of the linkage device 54.

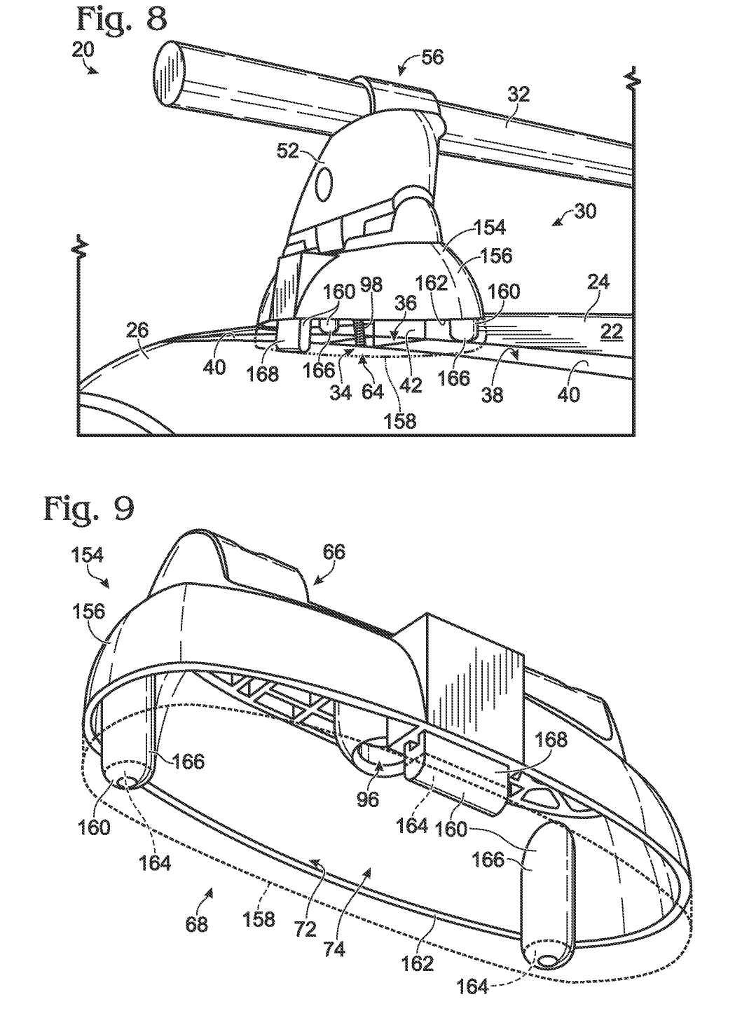

Another nonexclusive illustrative example of a linkage device is shown generally at 154 in FIGS. 8 and 9. Unless otherwise specified, linkage device 154 and/or its various components may, but are not required to, contain at least one of the structure, components, functionality, and/or variations described, illustrated, and/or incorporated herein. The linkage device 154 may include a body 156, a resilient pad or skirt 158, an anchoring member 64, and an interface 66. As shown in FIGS. 8 and 9, a plurality of posts or projections 160 may be disposed proximate the lower edge 162 of the body 156. The anchoring member 64 may be configured to engage one of the attachment points 34 and selectively urge the projections 160 against the resilient pad 158 and/or the upper surface 22 of the vehicle 26 and to urge the resilient pad 158 against the upper surface 22. In some examples, a portion of the resilient pad 158 may be compressed between the projections 160 and the upper surface 22 such that the resilient pad 158 isolates and/or protects the upper surface of the vehicle from the projections 160. In some examples, the projections 160 may include a resilient tip 164.

In some examples, at least some of the projections 160 may be configured as fixed projections 166 while one or more of the projections 160 may be configured as adjustable and/or interchangeable projections 168. Inclusion of one or more adjustable and/or interchangeable projections 168 may permit adjustment of the linkage device 154 relative to the upper surface 22, such as to account for variation in the upper surface profile and/or shape.

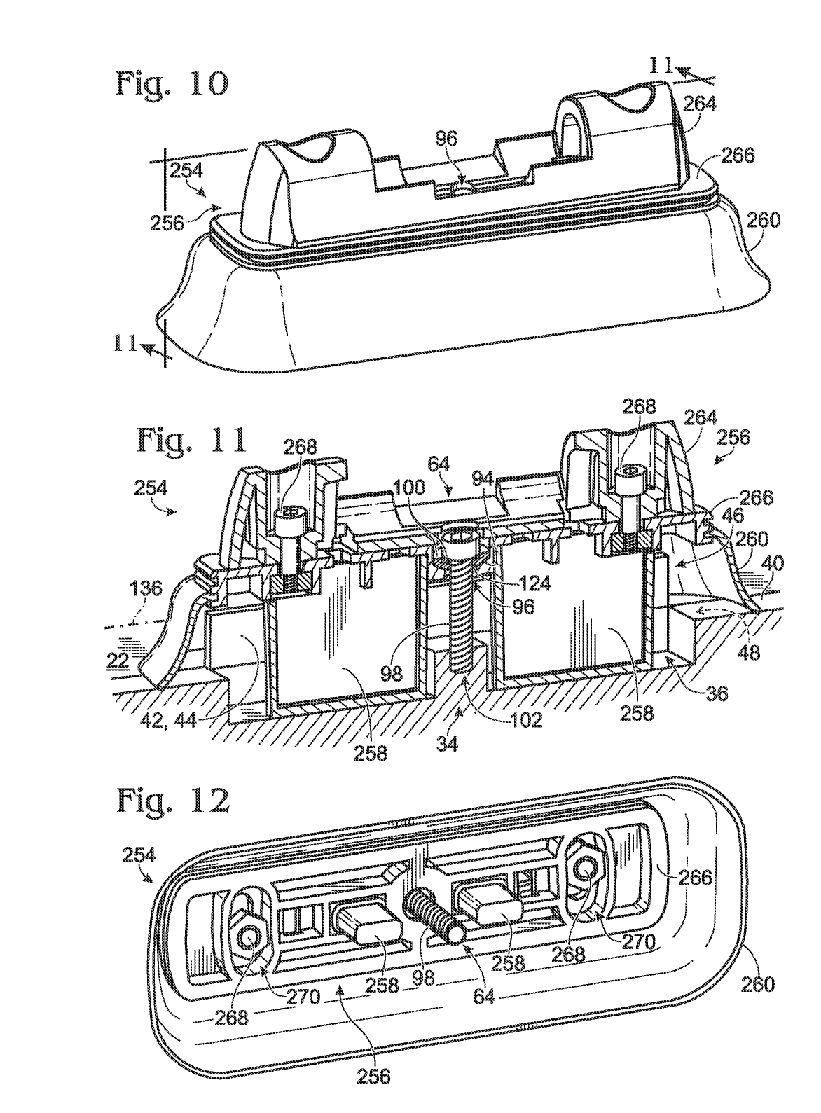

Another nonexclusive illustrative example of a linkage device is shown generally at 254 in FIGS. 10-12. Unless otherwise specified, linkage device 254 and/or its various components may, but are not required to, contain at least one of the structure, components, functionality, and/or variations described, illustrated, and/or incorporated herein. The linkage device 254 may include a body 256, at least one leg or post 258, a resilient pad or skirt 260, an anchoring member 64, and an interface 66.

As shown in FIG. 11, the anchoring member 64 may be configured to engage one of the attachment points 34 and selectively urge the posts 258 against the bottom 114 of the pocket 36 and the urge the skirt 260 against the upper surface 22 of the vehicle. Although the anchoring member 64 selectively urges the skirt 260 against the upper surface 22 of the vehicle, the skirt 260 may provide relatively little support for the linkage device 254, with the posts 258 carrying a substantial portion of any load supported by the interface 66.

As shown in FIGS. 11 and 12, the posts 258 may be interchangeable with posts of different sizes and/or shapes. Use of various sizes and shapes of posts 258, and corresponding various lengths of the threaded fastener 98, may permit use of the linkage device 254 with pockets 36 of various sizes, lengths, widths and/or shapes, as well as providing clearance between the body 256 of the linkage device 254 and any hinged cover member 42 for the pocket 36. For example, as shown in FIG. 11, relatively wide and/or long posts 258 and a relatively long threaded fastener 98 may be used when the pocket 36 and/or the cover member 42 are relatively large. However, when the pocket 36 and/or the cover member 42 are relatively small, relatively narrow and/or short posts 258 and a relatively short threaded fastener 98 may be used, as shown in FIG. 12. In some examples, such as where the pocket 36 is relatively small, the posts 258 may be omitted such that anchoring member 64 selectively urges the body 256 against the against the upper surface 22 of the vehicle and/or the skirt 260.

In some examples, the body 256 of the linkage device 254 may include an interface portion 264 and an anchoring portion 266. As shown in the example of FIGS. 11 and 12, the interface portion 264 may be secured to the anchoring portion 266 by way of fasteners 268 that engage tracks 270 disposed on the anchoring portion 266 such that the interface portion 264 may be rotated or pivoted relative to the anchoring portion 266. Such pivoting or rotation may permit adjustment of the linkage device 254 for use with pockets 36 that are not substantially parallel to the long axis 136 of the vehicle 26, as described above in connection with FIG. 7. In some examples, tracks for the fasteners 268 may additionally or alternatively be disposed on the interface portion 264.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

The various structural members disclosed herein may be constructed from any suitable material, or combination of materials, such as metal, plastic, nylon, plastic, rubber, or any other materials with sufficient structural strength to withstand the loads incurred during use. Materials may be selected based on their durability, flexibility, weight, and/or aesthetic qualities.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A rack system for carrying items on an upper surface of a vehicle having a plurality of preexisting attachment points disposed on the upper surface, the upper surface having a profile, and the rack system comprising:
a crossbar; and
a pair of support devices configured to support the crossbar therebetween, each of the support devices comprising:
a tower portion having a holding mechanism for securing a portion of the crossbar;
a base portion having an interface configured to support and retain the tower portion, the base portion including a substantially hollow lower portion having a lower edge that defines a circumference of an opening;
a resilient pad extending around at least a first substantial portion of the circumference of the opening, wherein the opening is substantially unimpeded by the resilient pad; and
an anchoring member configured to extend through the substantially hollow lower portion and through the opening, engage one of the preexisting attachment points, and selectively urge the resilient pad against the upper surface of the vehicle around at least a second substantial portion of the circumference of the opening substantially accommodating the profile of the upper surface.

2. The rack system of claim 1, wherein the anchoring member selectively compresses the base portion against the resilient pad and the upper surface of the vehicle, and all compressive loads transmitted between the base portion and the upper surface of the vehicle pass through the resilient pad.

3. The rack system of claim 1, wherein the second substantial portion of the circumference of the opening is coextensive with the first substantial portion of the circumference of the opening.

4. The rack system of claim 1, wherein the resilient pad is urged against the upper surface of the vehicle over a substantially contiguous contact area of the upper surface, and the one of the preexisting attachment points that is engaged by the anchoring member is disposed within a region of the upper surface that is exclusive of the contact area and substantially surrounded by the contact area.

5. The rack system of claim 1, wherein:
the upper surface of the vehicle includes a cover member disposed proximate the one of the preexisting attachment points that is engaged by the anchoring member;
the cover member is configured to pivot between an open position, in which the cover member projects above the upper surface of the vehicle and exposes the one of the preexisting attachment points that is engaged by the anchoring member, and a closed position, in which the cover member is substantially flush with the upper surface of the vehicle and would substantially conceal the one of the preexisting attachment points; and
the cover member, in its open position, extends through the opening and into the substantially hollow lower portion of the base portion when the anchoring member urges the resilient pad against the upper surface of the vehicle.

6. The rack system of claim 1, wherein the base portion includes a bearing surface, an aperture extends through the bearing surface and into the substantially hollow lower portion, the anchoring member includes a threaded fastener extending through the aperture, at least the one of the preexisting attachment points that is engaged by the anchoring member includes a threaded receiver disposed below the upper surface of the vehicle, and the threaded fastener engages the threaded receiver to selectively urge the resilient pad against the upper surface of the vehicle.

7. The rack system of claim 1, wherein the base portion includes a bearing surface, an aperture extends through the bearing surface and into the substantially hollow lower portion, the anchoring member includes a threaded fastener extending through the aperture, at least the one of the preexisting attachment points that is engaged by the anchoring member includes an edge disposed below the upper surface of the vehicle, the anchoring member includes a hook having a female threaded socket, the threaded fastener engages the female threaded socket to selectively draw the hook toward the bearing surface, and the hook is configured to engage the edge and urge the resilient pad against the upper surface of the vehicle when the hook is drawn toward the bearing surface.

8. The rack system of claim 1, wherein the opening on the base portion is a first opening, the base portion includes a bearing surface, an aperture extends through the bearing surface and into the substantially hollow lower portion, the anchoring member includes a threaded fastener extending through the aperture, at least the one of the preexisting attachment points that is engaged by the anchoring member includes a second opening, the anchoring member includes an engager having a threaded receiver, the threaded fastener engages the threaded receiver to selectively draw the engager toward the bearing surface, and the engager is configured to engage the second opening and urge the resilient pad against the upper surface of the vehicle when the engager is drawn toward the bearing surface.

9. The rack system of claim 1, wherein the support device is configured such that the anchoring member urges the resilient pad against the upper surface of the vehicle around at least the second substantial portion of the circumference of the opening without inducing a bending moment into the crossbar independently of any particular profile of the upper surface.

10. The rack system of claim 1, wherein the interface is configured such that the tower portion is pivotable relative to the base portion.

11. A support device for securing a vehicle rack to a preexisting attachment point disposed on an upper surface of a vehicle, the support device comprising:
a tower portion having a holding mechanism for receiving and securing a portion of the vehicle rack;
a base portion having an interface configured to support and retain the tower portion, the base portion including a substantially hollow lower portion having a lower edge that defines a circumference of an opening;
a resilient pad extending around at least a first substantial portion of the circumference of the opening, wherein the opening extends through the resilient pad and into the substantially hollow lower portion; and
an anchoring member configured to extend through the substantially hollow lower portion and through the opening, engage the preexisting attachment point, and selectively urge the base portion against the resilient pad and the upper surface of the vehicle around a second substantial portion of the circumference of the opening, wherein the second substantial portion is substantially coextensive with the first substantial portion of the circumference of the opening.

12. The support device of claim 11, wherein all compression loads transmitted between the base portion and the upper surface of the vehicle pass through the resilient pad.

13. The support device of claim 11, wherein the base portion urges the resilient pad against the upper surface of the vehicle over a substantially contiguous contact area of the upper surface, and the preexisting attachment point is disposed within a region of the upper surface that is exclusive of the contact area and substantially surrounded by the contact area.

14. The support device of claim 11, wherein the base portion includes a bearing surface, an aperture extends through the bearing surface and into the substantially hollow lower portion, the anchoring member includes a threaded fastener extending through the aperture, the preexisting attachment point includes a threaded receiver disposed below the upper surface of the vehicle, and the threaded fastener engages the threaded receiver to selectively urge the base portion against the resilient pad and the upper surface of the vehicle.

15. The support device of claim 11, wherein the opening on the base portion is a first opening, the base portion includes a bearing surface, an aperture extends through the bearing surface and into the substantially hollow lower portion, the anchoring member includes a threaded fastener extending through the aperture, the preexisting attachment point includes a second opening disposed below the upper surface of the vehicle, the anchoring member includes a hook having a threaded receiver, the threaded fastener engages the threaded receiver to selectively draw the hook toward the bearing surface, and the hook is configured to engage the second opening and urge the base portion against the resilient pad and the upper surface of the vehicle when the hook is drawn toward the bearing surface.

16. The support device of claim 11, wherein the interface includes one or more recesses, and the tower portion includes one or more locking pins that are selectively movable into engagement with the one or more recesses to retain the tower portion when the tower portion is supported by the interface.

17. The support device of claim 16, wherein the locking pins define an axis, and the tower portion is pivotable about the axis when the tower portion is supported by the interface and the locking pins are engaged with the one or more recesses.

18. A linkage device for connecting a vehicle rack support member to a preexisting attachment point disposed on an upper surface of a vehicle, the linkage device comprising:
a body having an interface configured to engage and retain the support member, the body including a substantially hollow lower portion having a lower edge that defines a circumference of an opening;
a resilient pad disposed on the lower edge and extending around at least a first substantial portion of the circumference of the opening, wherein the opening extends through the resilient pad and into the substantially hollow lower portion; and
an anchoring member configured to extend through the substantially hollow lower portion and through the opening, engage the preexisting attachment point, and selectively urge the body against the resilient pad and the upper surface of the vehicle over a second substantial portion of the circumference of the opening, wherein the second substantial portion is substantially coextensive with the first substantial portion.

19. The linkage device of claim 18, wherein:
the preexisting attachment point is a factory-installed component of the vehicle;
the upper surface of the vehicle includes a cover member configured to pivot between a closed position, in which the cover member is substantially flush with the upper surface of the vehicle and would substantially conceal the preexisting attachment point, and an open position, in which the cover member projects above the upper surface of the vehicle and exposes the preexisting attachment point; and
the cover member, in its open position, extends through the opening and into the substantially hollow lower portion of the body when the anchoring member urges the body against the resilient pad and the upper surface of the vehicle.

20. The linkage device of claim 18, wherein the anchoring member selectively compresses the body against the resilient pad and the upper surface, and all compressive loads transmitted between the body and the upper surface of the vehicle pass through the resilient pad.

21. The linkage device of claim 18 wherein the anchoring member selectively urges the body against the resilient pad such that the resilient pad engages the upper surface of the vehicle over a substantially contiguous contact area on the upper surface, and the anchoring member passes through a region of the upper surface that is exclusive of the contact area and substantially surrounded by the contact area.

22. The linkage device of claim 18, wherein the resilient pad includes an outer edge, and a pliable skirt is disposed along the outer edge.

23. The linkage device of claim 18, wherein the interface is configured such that the support member is pivotable relative to the body.

24. The linkage device of claim 18, wherein the body includes a bearing surface, an aperture extends through the bearing surface and into the substantially hollow lower portion, the anchoring member includes a threaded fastener extending through the aperture, the preexisting attachment point includes a threaded receiver disposed below the upper surface of the vehicle, and the threaded fastener engages the threaded receiver to selectively urge the body against the resilient pad and the upper surface of the vehicle.

25. The linkage device of claim 18, wherein the body includes a bearing surface, an aperture extends through the bearing surface and into the substantially hollow lower portion, the anchoring member includes a threaded fastener extending through the aperture, the preexisting attachment point includes an edge disposed proximate the upper surface of the vehicle, the anchoring member includes an engager having a threaded receiver, the threaded fastener engages the threaded receiver to selectively draw the engager toward the bearing surface, and the engager is configured to engage the edge and urge the body against the resilient pad and the upper surface of the vehicle when the engager is drawn toward the bearing surface.
